(19) United States
(12) Patent Application Publication
(10) Pub. No.: US 2003/0146578 A1
(43) Pub. Date: Aug. 7, 2003

(54) Arrangement for the attachment of distributor sectors supporting vanes around an arc of a circle

(75) Inventors: Patrick Joseph Marie Girard, Melun (FR); Sebastien Alain Imbourg, Yerres (FR); Philippe Jean-Pierre Pabion, Vaux Le Penil (FR); Jean-Luc Soupizon, Vaux Le Penil (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SNECMA MOTEURS, Paris (FR)

(21) Appl. No.: 10/359,222

(22) Filed: Feb. 6, 2003

(30) Foreign Application Priority Data
Feb. 7, 2002 (FR) 02 01460

(51) Int. Cl. F16J 15/447

(52) U.S. Cl. 277/416

(57) ABSTRACT

Distributor sectors (25) on which fixed vanes are placed adjacent to a casing (31) by means of sealing sectors (32) alternating with them in the axial direction and provided with force resistant faces (37; 39) through which forces exerted on the distributor sectors are transmitted to the casing. The inner surface of the casing (31) is smoother and is not fitted with any hooks; consequently, this casing (31) is less complicated to make and is less mechanically stressed to retain the distributor sectors, and the distributor sectors may be installed by a purely axial movement.

This invention relates to an arrangement for the attachment of distributor sectors around the arc of a circle.

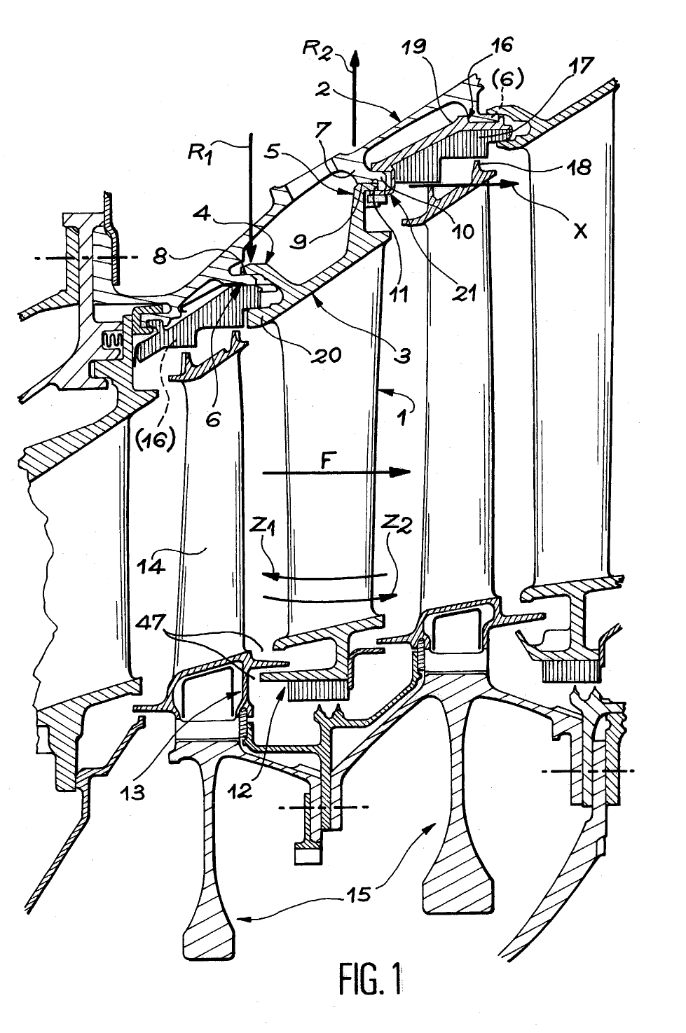

The distributors considered in this description are used in turbo machines and are fitted with vanes fixed to the stator with the function of straightening gas flows. Distributor sectors are installed inside the stator casing by interlocking hooks, allowing them to rest on bearing faces, some of which must resist the forces exerted on the distributor vanes. In the known embodiment in FIG. 1 in which the sectors are marked as reference 1 and the stator casing is marked as reference 2, the outer ring 3 of the distributor sectors 1 comprises an upstream tab 4 and a downstream tab 5, both hook shaped, and the casing 2 comprises upstream tabs 6 and downstream tabs 7 also hook shaped and associated in pairs with a given distributor. On the upstream side, the tab 4 of the sector 1 is engaged around the tab 6 of the casing 2, but on the downstream side the tab 7 of the casing 2 is engaged around the tab 5 of sector 1. This is justified if it is assumed that the forces F exerted on the distributor are essentially facing the downstream direction, and transmitted to the casing 2 partially in the form of a moment comprising a centripetal radial force R1 on the upstream side and a centrifugal force R2 on the downstream side. Therefore, the tabs 4 and 5 of the sectors 1 are bearing on the tabs 6 and 7 of the casing 2 at the contact faces 8 and 9 that are force resistant faces. The axial component of the forces F is also transmitted to the casing 2 through an axial force X exerted on the downstream side of the tab 5, at a curved hook shaped end 10 of the tab 7; therefore the contact face between the tab 5 and the end 10 is an axial force resistance face 11.

One disadvantage of this design is that the tabs 6 and 7 of the casing 2 are highly loaded, which is particularly problematic because their hook shape makes them weak and they become particularly hot under service conditions because they project into the gas stream, and the intrinsic strength of the material from which they are made may be weakened. The casing weight is increased by the tabs that have to be made solid, manufacturing becomes more difficult due to the complicated shape and in practice it must be constructed from a fairly noble material, which is not justified by the forces that it must resist in areas away from the tabs.

Another disadvantage of this design becomes clear during assembly; since the tab 5 on the downstream side of the sectors 1 passes below the curved hook shaped end 10, the sectors 1 must be presented obliquely, and then rotated after they are engaged behind the curved hook shaped end 10, to come into contact with the downstream force resistance face 9. The deflections Z1 and Z2 illustrate this inclination and then straightening movement of the sectors 1 during assembly. It can be seen that sufficient clearance has to be allowed between an inner ring 12 of the sectors 1 and an inner ring 13 of stages of vanes 14 of the rotor 15, so that leak tightness may not be very good at this location.

When the distributor sectors have been put into place, it is possible to install sealing sectors 16 on the downstream side that include an “abradable” material ring 17 that cooperates with lip seals 18 of the mobile vanes 14 to form labyrinth seals, which also include a support ring 19 for which the ends are configured to fit onto the tabs 6 and 7 of the casing 2. The attachment system is similar to the attachment system for the distributor sectors 1, since the ring 19 is supported on the upstream side on a radially outer face of one of the tabs (7) of the casing 2, and on the downstream side on a radially inner face of the other tab (6). Finally, the distributor and sealing sectors 1 and 16 that alternate in the machine in the axial direction are assembled to each other since the outer ring 3 of the distributor sectors 1 is provided with a tab 20 on the upstream side that is engaged in the downstream end of the adjacent sealing sectors 16, and the sealing sectors 16 also have an upstream tab 21 engaged under the downstream tab 5 of the adjacent ring 3 of the distributor 1. The tabs 20 and 21 hold the sectors 1 and 16 in position.

Document U.S. Pat. No. 4 529 355A describes an arrangement in which the casing supports the sealing and distributor sectors through spacers screwed onto it. Therefore it is smooth, but the hooks are on spacers that are heavy and cumbersome. Therefore this prior design seems to be even less attractive.

The present invention relates to an arrangement for attaching a different type of distributor sectors, the essential purpose of which is to avoid the use of hook shaped tabs belonging to the casing, in order to simplify the casing and to make the assembly of the distributor more convenient. The basic idea on which the invention is based is that the faces that resist forces in the axial and radial outwards directions are now located on the sealing sectors, the casing essentially providing only bearing faces that resist little or no load, such that the forces that it needs to resist will be very significantly reduced.

One significant form of the invention is characterized in that the distributor and sealing sectors comprise tabs with two axially opposite ends, the tabs of the distributor sectors are clamped between the tabs of the sealing sectors and the casing, and the sealing sectors are fixed to the casing by a median portion.

In some particular embodiments, an attempt is made to reduce forces transmitted to the casing by the sealing sectors, and particularly the moment resulting from forces produced on the different bearing faces.

All aspects of the invention will now be described by comparing the following figures:

FIG. 1, already described, illustrates an arrangement for attachment of a known type of distributor sector;

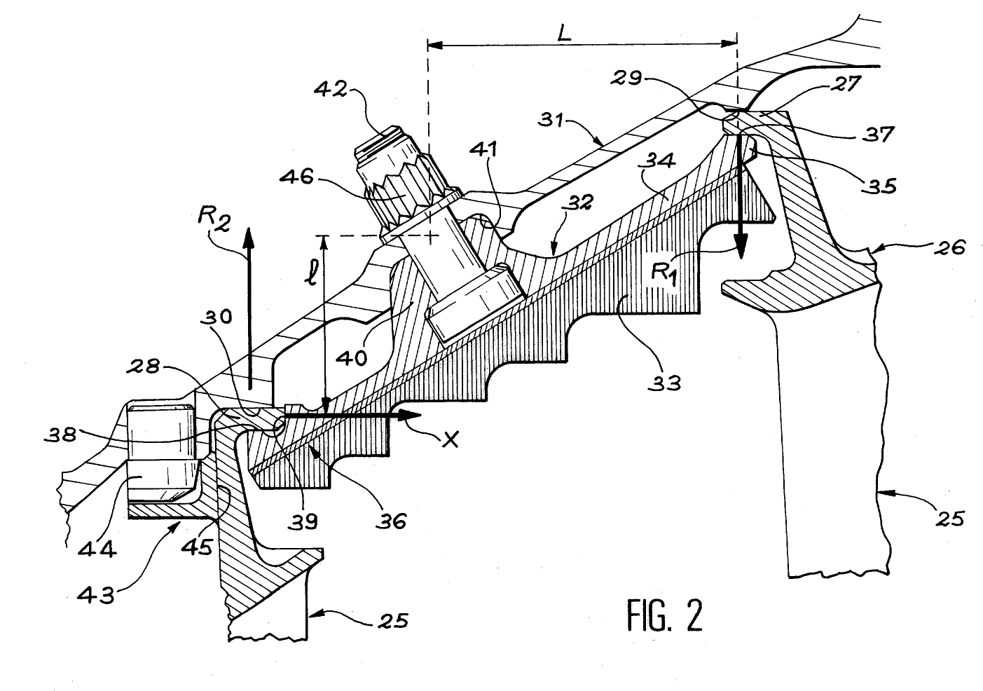

and FIG. 2 illustrates the arrangement according to the invention in a preferred embodiment.

The overall shape of distributor sectors, which are globally denoted reference 25, is not significantly modified, and they still comprise an outer ring 26 provided with a tab 27 on the upstream side and a tab 28 on the downstream side. The tabs 27 and 28 bear on their outside faces on radial faces 29 and 30 facing the inside of the casing, which is now denoted as reference 31. Sealing sectors, now denoted 32, are still arranged alternately with the distributor sectors 25, and in addition to an abradable ring 33, they also comprise an outer ring 34 of which the downstream end 35 and the upstream end 36 clamp the tabs 27 and 28 to each other and between the bearing faces 29 and 30 of the casing 31, respectively. More precisely, the downstream end 35 supports a radial bearing face facing the outside 37 on which the centripetal radial force R₁ is applied, and the upstream end 36 supports a radial bearing face facing the outside 38 and an axial bearing face 39 resisting the axial force X. The outer rings 34 are connected to the casing 31 with a median portion on which a rib 40 (or a projection) is formed penetrating into a complementary shaped groove 41 (or hollow) on the casing 31 to precisely adjust the position of the sealing sectors 32. Screws 42 are engaged through the projection 40 and the casing 31 to fix the sealing sectors 32 to the casing. These screws (42) are fixed to the casing by nut 46. Another attachment means such as a force fitted pin could fill the same function.

Most forces applied on the distribution sectors 25 are resisted by sealing sectors 32. Therefore, these sealing sectors must be designed accordingly, but they will be less loaded than the hook shaped tabs of casing 2 according to the known embodiment.

The complicated and weak shapes actually disappear from the casing 31 like sealing sectors 32. The bearing faces 29 and 30 of the casing 31 are made on solid and therefore strong parts. The radial force R2 and the axial force X exerted by the tab on the downstream side 28 are exerted on different parts, which relieves the two parts.

Furthermore, the forces R₁ and X exert opposing moments R₁xL and Xxl on the outer ring 34 about the attachment point of the screw 42 to the casing 31, and the lever arms L and l of the forces R and X respectively can be adjusted by making a judicious choice of the position of the screw 42 such that their moments have comparable values and that the bending produced on screw 42 is therefore very much reduced. Furthermore, it can be seen that the distributor sectors 25 can be installed by purely axial movements, the sealing sectors 32 then being installed behind them which is more convenient and gives more freedom in determining the layout of the machine. Overhanging parts 43 fixed to the casing 31 by pins 44 can be added to provide an axial stop face 45 for the distributor sectors 25.

Furthermore, this typical axial assembly is a means of reducing axial clearances between the stator vanes (inner ring 12 of sectors 1 in FIG. 1) and the rotor vanes (inner ring 13 of the rotor vanes 15 in FIG. 1); consequently, this reduces leakage sections (47) between the rotor and the stator making the vane assembly more efficient.

Although the view in FIG. 2 is not as complete as the view in FIG. 1, it should be understood that the invention can be extended to a group of stages of distributor sectors 25 and sealing sectors 32, and particularly that one stage of distributor sectors 25 bears at its two ends on two successive stages of sealing sectors 32, in the manner described. A particular effort has been made to show the sealing sectors 32, since the distributor sectors 25 are essentially the same as those in FIG. 1.

1. Arrangement for attachment of vane support distributor sectors (25) to a stator casing (31) around an arc of a circle, including bearing faces (29, 30, 37, 38, 39) in the radial and axial directions for the sectors, distributed on the casing, and independent attachment parts, including at least one face facing radially outwards (37) and one face facing the radial direction (39) both of which resist forces applied on the vanes in the sectors, sealing sectors (32) being fixed to the casing and alternating with the distributor sectors in the axial direction, characterized in that the said force resistance faces facing the radially outwards direction and the axial direction are located on the sealing sectors.

2. Arrangement for attachment of distributor sectors around an arc of a circle according to claim 1, characterized in that the distributor and sealing sectors comprise tabs at two opposite axial ends, the tabs (27, 28) of the distributor sectors are tightened between the tabs (35, 36) of the sealing sectors (32) and the casing (31), and the sealing sectors are fixed to the casing at a median position.

3. Arrangement for attachment of distributor sectors around an arc of a circle according to claim 2, characterized in that the sealing sectors are fixed to the casing by an element (42) passing through the casing and comprising means of positioning on the casing.

4. Arrangement for attachment of distributor sectors around an arc of a circle according to either claim 2 or 3, characterized in that the axially oriented face (39) resisting forces is axially located on the upstream side of the sealing sectors, and the radially oriented face facing outwards (37) and resisting forces is axially located on the downstream side of the sealing sectors.

5. Arrangement for the attachment of distributor sectors around an arc of a circle according to claims 3 and 4, characterized in that the sealing sectors are designed such that the forces resisted by the force resistance faces exert opposing moments (R1xL, Xxl) with approximately equal values on the elements passing through the casing.
